(19) United States
(12) Patent Application Publication
(10) Pub. No.: US 2011/0054792 A1
(43) Pub. Date: Mar. 3, 2011

(54) System and method for determining relative positions of moving objects and sequence of such objects

(75) Inventor: Scott McClellan, Heber City, UT (US)

(73) Assignee: inthinc Technology Solutions, Inc., West Valley City, UT (US)

(21) Appl. No.: 12/805,936

(22) Filed: Aug. 25, 2010

Related U.S. Application Data
(60) Provisional application No. 61/236,853, filed on Aug. 25, 2009.

(51) Int. Cl. G06F 17/00

(52) U.S. Cl. 701/300

(57) ABSTRACT

A system and method for ranking the relative movement of objects on a pathway is provided. The method includes: dividing the pathway into a plurality of sectors, each sector having a rank of order with respect to a beginning and an ending point of the pathway; receiving coordinate data from each of the objects; identifying, based on the received coordinate data, if any objects are present in individual ones of the plurality of sectors; determining, for any sector that has at least two objects, the positional order of the at least two objects within that sector; and ranking the positional order of the plurality of objects along the pathway based upon the rank order of the sector in which each object is present, and which multiple objects that are present in any sector are ordered as set by the determining.

### CROSS REFERENCE TO RELATED APPLICATIONS

The present application claims priority to U.S. Patent Application 61/236,853 entitled SYSTEM AND METHOD FOR DETERMINING RELATIVE POSITIONS OF MOVING OBJECTS AND SEQUENCE OF SUCH OBJECTS filed on Aug. 25, 2009, the disclosure of which is expressly incorporated by reference herein in its entirety.

### BACKGROUND OF THE INVENTION

1. Field of the Invention

The present invention relates to a system and a method for determining the location of moving objects relative to each other in real time. More specifically, the present invention relates to determining the position of moving objects, such as race cars, relative to each other, so that the order of such objects can be determined.

2. Discussion of Background Information

Popularity of the sport of racing has risen dramatically over the last decade. As is well known, racing involves moving objects, such as cars, boats, people, animals, etc., around a fixed course. The winner is the participant that crosses the finish line first, although secondary prizes may be awarded (e.g., place and show) for various positions other than the winner.

Information on the relative position of the participants during the race may also be of interest. For example, when the race is being broadcast, the broadcasters often include a ticker of the order of the race participants. Such information may also be valuable to comply with the race rules, such as auto racing, where the race can be stalled due to a “yellow flag” condition and the drivers are responsible for maintaining their order in the race while the yellow flag conditions persist.

With respect to crossing the finish line, position can often be detected with the naked eye if the participants cross at distinct enough intervals. However, the naked eye method may not be reliable if the participants are too close to each other. A variety of technologies have thus emerged to provide an accurate accounting of events at the finish line. For example, the so-called “photo finish” refers to the use of a camera triggered by the passage of the lead object past the finish line which allows the visual observation of the winner and/or order of participants. More recently, in the field of auto racing, cars are equipped with inductive coils that interact with equipment proximate to the finish line, which triggers a signal as the cars cross the finish line. This methodology provides highly reliable information on the order in which each car crosses the finish line.

While the above technologies are useful for monitoring the finish line, they are ineffective in determining the status of other events around the race course, particularly for identifying the order of the racing participants at any given time. Currently, the order of participants in the race is provided manually via “spotters” who physically observe the race and monitor/record the position of the participants. For instance, a typical NASCAR race uses about 20 such spotters, which entails a significant expense.

It has been suggested to create artificial “finish” lines around the track to leverage the use of the inductive coils, but, in effect, an infinite amount of such artificial finish lines would be necessary to provide accurate results. There is presently no commercial technology for providing an accurate order of the participants in real time absent manual visual observation.

### SUMMARY

According to an embodiment of the invention, a method for ranking the relative movement of objects on a pathway is provided. The method includes: dividing the pathway into a plurality of sectors, each sector having a rank of order with respect to a beginning and an ending point of the pathway; receiving coordinate data from each of the objects; identifying, based on the received coordinate data, if any objects are present in individual ones of the plurality of sectors; determining, for any sector that has at least two objects, the positional order of the at least two objects within that sector; and ranking the positional order of the plurality of objects along the pathway based upon the rank order of the sector in which each object is present, and which multiple objects that are present in any sector are ordered as set by the determining.

The above embodiment may have an optional feature where the pathway defines a closed loop that the plurality of objects will repeatedly travel over a number of laps, and the plurality of sectors covering a single lap of the number of laps. The method would optionally also include: identifying those of the plurality of objects that are in a first particular lap; performing the identifying and determining only for those of the plurality of objects that are associated with the first particular lap, while disregarding others of the plurality of objects that are associated with a different lap; wherein the ranking the positional order of the plurality of objects along the pathway is based upon a rank order of the number of laps, within each lap the rank order of the sectors in which each object is present, in which multiple objects within any sector for any common lap are ordered as set by the determining.

The above embodiment may have various additional optional features. A forward edge of a highest ranking sector of the plurality of sectors may align with a predetermined end of the pathway. The pathway may includes a start line and a finish line, where a forward edge of a highest ranking sector of the plurality of sectors aligns with the finish line, and a rearward edge of the lowest ranking sector of the plurality of sectors aligns with the start line. The pathway may define a loop, and the start line and the finish line are the same line. The positional order may be visually displaying as established by the ranking. The steps of receiving, identifying, determining, and ranking steps may be recursively performed such that the positional order of the objects as they move along the pathway is monitored and updated. The recursively performing may occur in near real-time. The determining may include: determining from the received coordinate data the distance of each of the at least two objects to a forward edge of the sector, and ordering the at least two objects based upon the shortest to longest distance; or determining from the received coordinate data the distance of each of the at least two objects to a rear edge of the sector, and ordering the at least two objects based upon the longest to shortest distance. The ranking may include, for each sector, recursively in rank order sequence from the highest to the lowest, listing the objects in each sector to collectively provide a priority order list of the objects for the plurality of sectors. The ranking may include for each sector that includes an object, recursively in rank order sequence from the highest to the lowest, listing the objects in each sector to collectively provide a priority order list of the objects for the plurality of sectors.

The pathway may have at least one branch, which may be a pit area with an entrance and an exit that connects to the pathway, and the dividing step includes the pit area.

According to another embodiment of the invention, a method for ranking the relative movement of objects that are lapping a pathway is provided. The method includes: dividing the pathway into a plurality of sectors, each sector having a rank of order with respect to a beginning and an ending point of the pathway; identifying, for each object on the track, a lap in which the object is in and which of the plurality of sectors the object is in; determining, for any sector that has multiple objects in a common lap, the position order of the multiple objects within that sector and common lap; and generating a positional order of the objects along the pathway based upon the rank order of the lap in which each object is present, within each lap the rank order of the sector in which each object is present, and which multiple objects within any sector within a common lap are ordered as set by the determining.

The above embodiment may have various features. A forward edge of a highest ranking sector of the plurality of sectors may align with a predetermined end of the pathway. The pathway may include a start line and a finish line, a forward edge of a highest ranking sector of the plurality of sectors aligns with the finish line, and a rearward edge of the lowest ranking sector of the plurality of sectors aligns with the start line. The pathway may define a loop, and the start line and the finish line are the same line. The positional order of the objects may be visually displayed as established by the ranking. The receiving, identifying, determining, and generating steps may be recursively performed such that the positional order of the objects as they move along the pathway is monitored and updated. The recursively performing may occur in near real-time. The determining may include: determining from the received coordinate data the distance of each of the at least two objects to a forward edge of the sector, and ordering the at least two objects based upon the shortest to longest distance; or determining from the received coordinate data the distance of each of the at least two objects to a rear edge of the sector, and ordering the at least two objects based upon the longest to shortest distance. The pathway may have at least one branch, where the branch may be a pit area with an entrance and an exit that connects to the pathway, and the dividing step includes the pit area.

According to another embodiment of the invention, a method for ranking the relative movement of objects that are lapping a race pathway is provided. The method includes: dividing the pathway into a plurality of sectors, each sector having a rank of order with respect to a beginning and an ending point of the pathway; receiving coordinate data from each of the objects; establishing the highest current n^{th} lap in the race, where n is an integer; recursively for each k^{th} lap in order from n to a lowest lap: (a) identifying any of the objects in the k^{th} lap; recursively for each sector, in order from a highest ranking sector to a lowest ranking sector: (i) identifying whether any of the objects within the k^{th} lap are within the sector; (ii) if multiple objects are in the sector, determining a positional order of the multiple objects within the sector; and (b) displaying the positional order of the objects along the pathway in lap and sector order, including order of multiple objects within a sector pursuant to the determining.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 illustrates an embodiment of an overall system for monitoring the position of vehicles;

FIG. 2 illustrates an embodiment of tracking components that are mounted in a vehicle;

FIG. 3 illustrates an embodiment in which tracking components are mounted in different locations of two different vehicles;

FIG. 4 illustrates an embodiment of a mobile monitoring center;

FIG. 5 illustrates vehicles on a racetrack;

FIG. 6 illustrates an embodiment of the invention in which the racetrack is broken up into sectors;

FIG. 7 illustrates an embodiment of the invention in which the relative position of each race car is determined on a sector-by-sector basis;

FIG. 8 illustrates an embodiment of a display of the racetrack, cars, and relevant tracking data;

FIG. 9 illustrates an embodiment of the invention in which the racetrack is broken up into sectors; and

FIGS. 10A-10C illustrate the operation of an embodiment of the invention.

### DETAILED DESCRIPTION OF EXEMPLARY EMBODIMENTS

The particulars shown herein are by way of example and for purposes of illustrative discussion of the embodiments of the present invention only, and are presented to provide what is believed to be the most useful and readily understood description of the principles and conceptual aspects of the present invention. In this regard, no attempt is made to show structural details of the present invention beyond those necessary for the fundamental understanding of the present invention, as the description taken with the drawings make it apparent to those skilled in the art how the several forms of the present invention may be embodied in practice.

As noted above, embodiments of the present invention are directed to any environment in which it is desirable to monitor the movement of objects within an area. Sports are but one possible implementation of the methodology, racing is but one implementation of the methodology in sports, and auto racing is but one implementation of the methodology in racing. For ease of discussion, the embodiments herein focus on auto racing. However, the invention is not so limited, and the methodologies described herein may be provided in any environment.

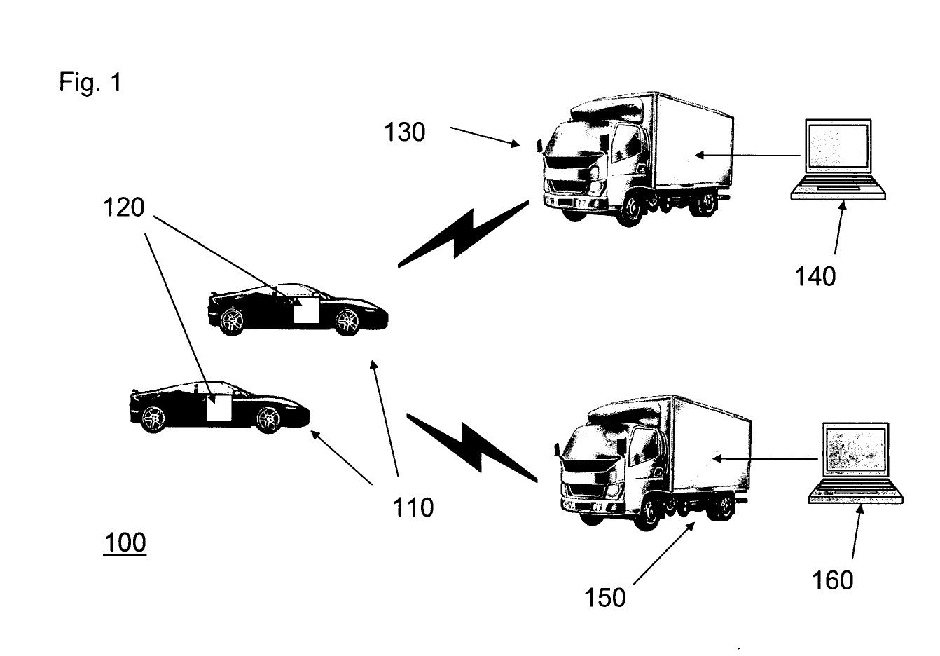

Referring now to FIG. 1, an overall view of a monitoring system 100 is shown. A plurality of racing cars 110 are each equipped with a position detector 120. Each position detector is in communication with a central location 130, which collects position information from each of the racing cars 110. A processor 140 at central location 130 processes the position data of the racing cars 110 to collectively determine the position and sequence characteristics of the race course, and outputs that information in a visual viewable format. A secondary location 150 with its own processor 160 may also receive position information from each of the racing cars 110 to act as a back up system.

Position detector 120 is preferably a DGPS receiver that is used to determine geographic coordinates (e.g., latitude and longitude), although other methods of detecting position location could also be used. As is known in the art, DGPS receivers receive signals from at least 3 GPS satellites and receive an additional ground-based signal. Position detector 120 may determine its own geographic coordinates directly, or may simply collect raw data from the DGPS network and forward the data to processor 140 for later conversion into geographic coordinates. The conversion of the raw data into geographic coordinates may take place at any point inside or outside of the system.

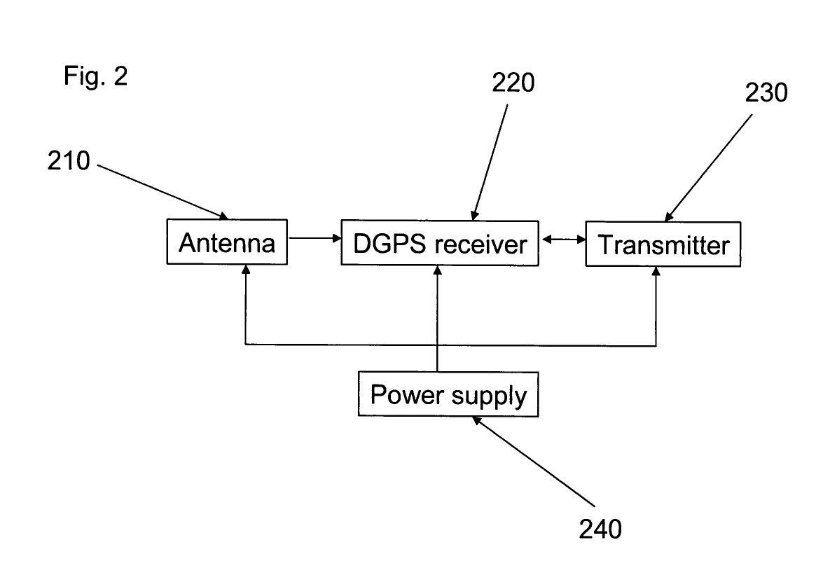

FIG. 2 shows an example of components of position detector 120 when implemented as a DGPS. Position detector 120 includes at least one antenna 210, a receiver 220, a transmitter 230, and a power source 240. As is known in the art, receiver 220 receives DGPS data from available sources and produces a set of latitude and longitude coordinates for the receiver 220. Transmitter 230 then transmits the coordinate information to central location 130, preferably through a cellular connection and/or an RF transmission (multiple different transmission methods may be used for redundancy in case of any localized system failure). Preferably, the components of position detector 120 are selected to provide geographic coordinates that are accurate on the order of centimeters, and more preferably on the order of millimeters.

The embodiments herein are not limited to any specific component or architecture. However, to ensure fairness and comparable results, each racing car 110 preferably uses the exact same equipment and configuration, or is limited to a pre-approved list of equipment and configurations to utilize. Also, since the system considers the position of each car to be the position detected by position detector 120, each racing car 110 preferably has its position detector 120 at the same relative location within the vehicle, e.g., close to the front or center.

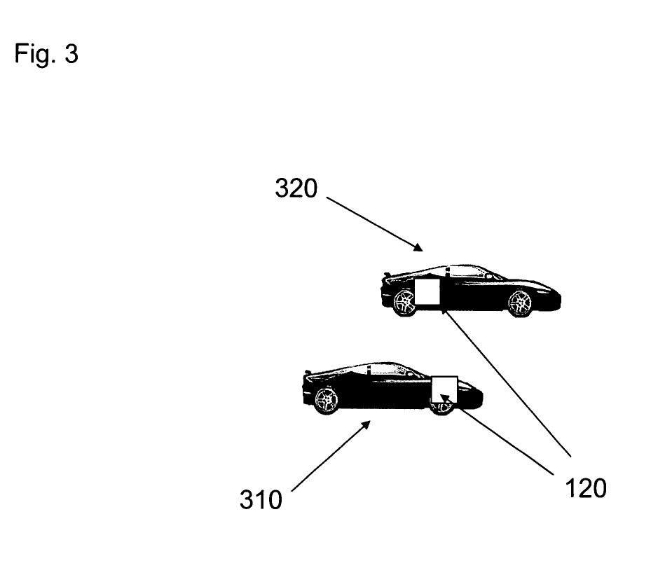

The need for similar placement of position detectors 120 in racing cars 110 is illustrated in FIG. 3. Car 310 has its position detector 120 in the front, and car 320 has its position detector in the back. In FIG. 3 car 320 is ahead of car 310, such that car 320 is in the lead. Yet the position detector 120 of car 310 is ahead of the position detector 120 of car 310, and would thus indicate, incorrectly, that car 310 is in the lead.

The above differential placement of position detector 120 could be compensated for if the system knows the exact placement of position detector 120 within each vehicle, and could thus be an alternative embodiment of the invention. There may also be other environments in which the differential placement of position detector 120 is not sufficient to impact the system, such that the location requirements for position detector 120 can be relaxed and compensation is not necessary.

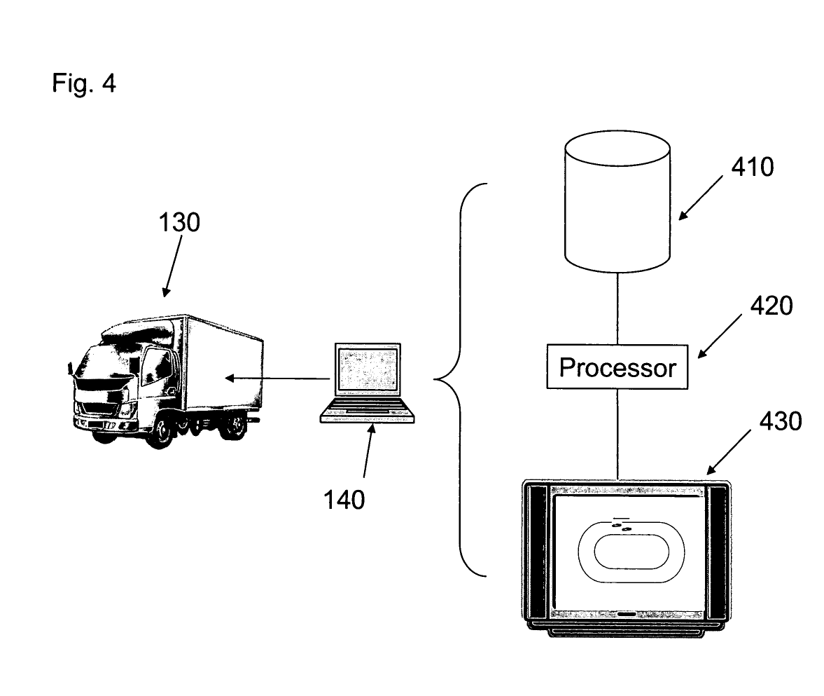

Referring now to FIG. 4, central location 130 is preferably a mobile trailer that can be moved from race track to race track as necessary. However, the invention is not so limited, and a fixed location could be used. In addition, central location 130 may be a single location as in FIG. 4, or a collection of operations dispersed over a geographic area. There may also be multiple central locations that provide complementary or duplicative operations. All of these possibilities fall within the meaning of “central location” as used herein.

Central location 130 includes a memory 410, a processor 420 (which corresponds to processor 140 of FIG. 1) and one or more displays 430. Processor 420 is preferably a combination of software and hardware, the software being contained on a tangible computer readable medium and executable on electronic computer hardware; the processor may be implemented via a single computer at the single location, or dispersed via operations at multiple locations . Memory 410 is preferably a bulk storage for computer systems such as a computer hard drive or other tangible storage medium, e.g., flash drive, CD, etc. The invention is not limited to any particular type of memory, display, software or hardware other than as necessarily configured to carry out the features of the embodiments discussed herein.

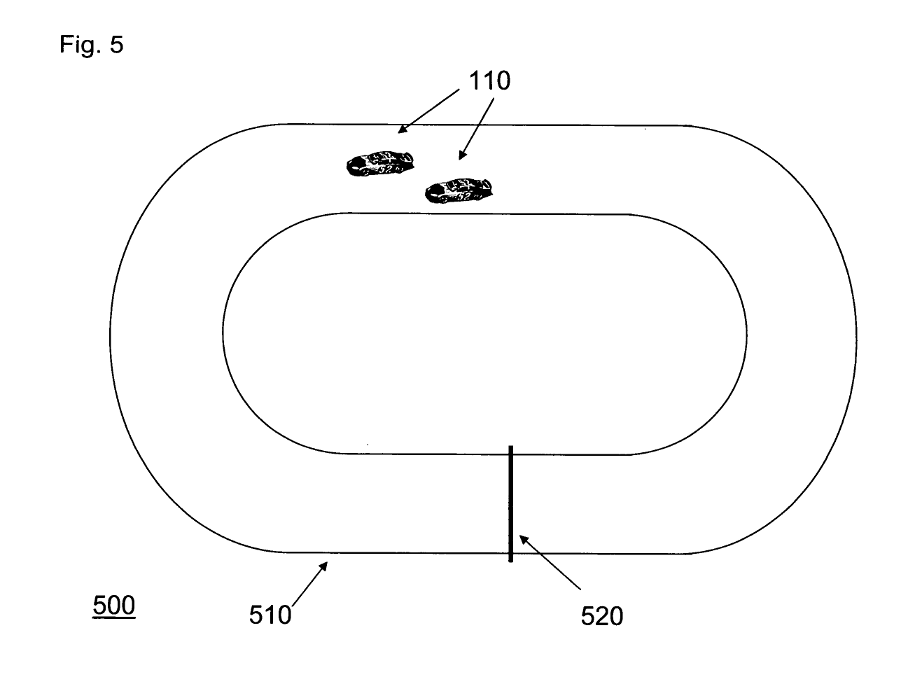

Referring now to FIG. 5, central location 130 will preferably store in memory an accurate map or image (collectively “map”) of the race track 510 with a finish line 520 for display on display 430. Map 500 preferably is geo-registered, so that one or more distinct points (preferably including the finish line) on the map have known geographic coordinates. Processor 420 will process in real time the coordinate data from the individual racing cars 110, correlate the same with map 500, and accurately identify the location of each car 110 on map 500 for purposes of display on display 430 in real time. Coordinate data are also stored in memory 410, such that the location of all racing cars 110 on the track can be identified for any particular prior point in time.

Presuming that the race involved a multi-lap event, preferably the system will be aware of which lap the individual cars are in. More specifically, a trailing car may be directly behind the lead car, and thus by position would appear to be in second place; but if the trailing car is actually a lap behind the lead car, the trailing car could actually be closer to last place. The lap of each car may be known by prior art methods, such as recorded visually by spotters, or by a counter triggered via the induction coils passing the start/finish line. Alternatively, processor 420 can monitor the laps via the location data. The embodiments herein are not limited to any particular mechanism for lap counting.

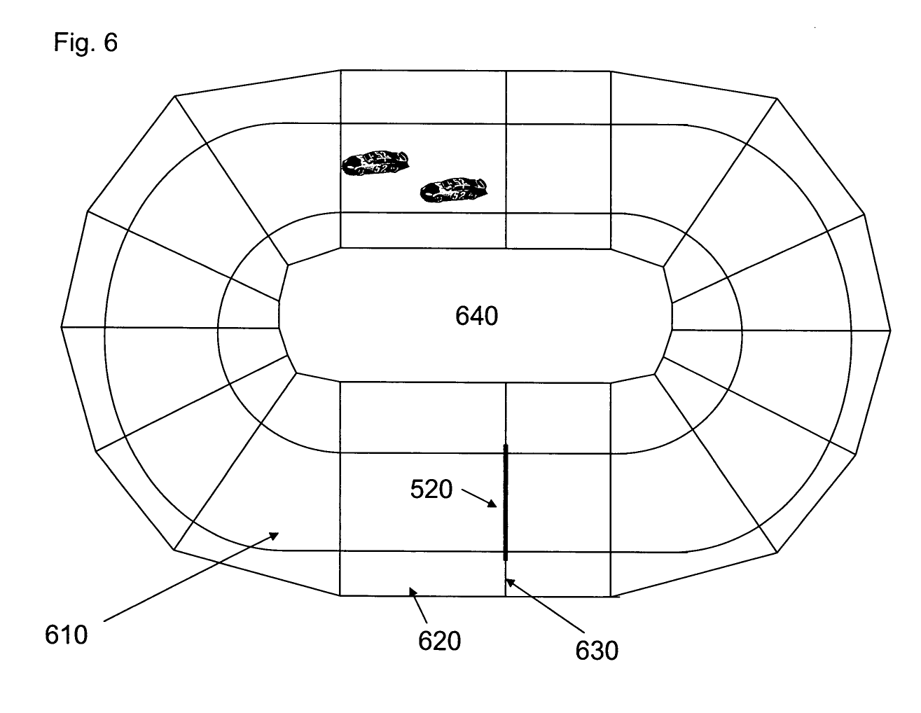

Referring now to FIG. 6, to identify the order of cars, processor 140 (or 420) delineates the race track 610 (a capsule shaped track in FIG. 6) into individual sectors 620. For events that include a side area (such as the pit in auto racing), a distinct off track sector 640 may also be provided. Each sector 620 preferably has three minimum defining characteristics, namely, that (1) at least one edge 630 of the sector 620 is perpendicular to the race track 610, (2) the geographic coordinates of at least one edge 630 of the sector 620 is known, and (3) all sectors 620 collectively cover the entire race track 610. In FIG. 6, the sectors 620 are contiguous, and adjacent sectors share boundaries such that there are two edges 630 perpendicular to the race track 610 in each sector; and the sectors 620 remain static for the duration of the race. However, the invention is not so limited, as the sectors 620 need not be adjacent and contiguous, but could overlap. Preferably at least one sector 620 has its perpendicular edge in alignment with the start and/or finish line.

Each sector 620 is also typically of a size and shape that is consistent with the race track 610 section that it covers. Thus, a sector 620 on a straightaway portion of the track 610 may be rectangular, while the sector 620 on a curved portion of a track 610 may have an arc shape. Sectors 620 may have the same general square footage of coverage, or may be different. By way of non-limiting example, curved areas of the track may require greater degrees of precision than straightway areas, such that sectors in curved areas are smaller in size then other areas.

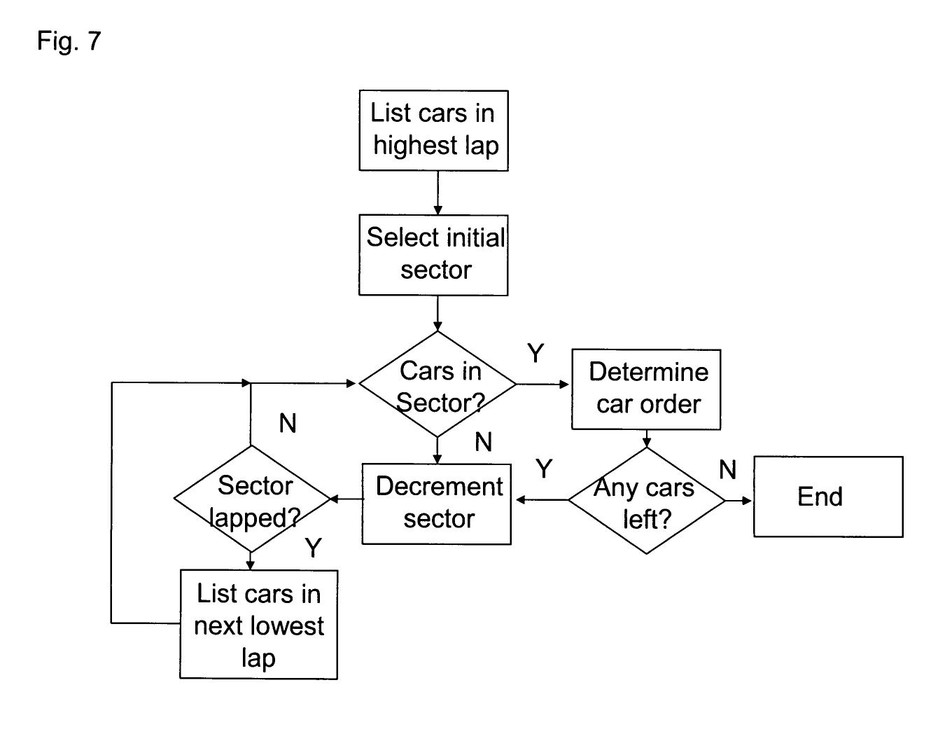

Referring now to FIG. 7, to identify the order of the cars at a particular point in time, processor 140 isolates a list of those cars that are in the highest common lap. Processor 140 will then select an initial forward most sector 620; the sector 620 that covers the area just prior to the finish line 520 is a convenient starting point, although the invention is not so limited. If no racing cars 110 are present in that sector, then processor 140 looks downstream (opposite the flow of race traffic) to the immediately preceding sector 620 along track 610. The process continues until a sector 620 is identified as containing one or more cars in the list of those within the highest lap. For instance, in FIG. 6, no racing cars 110 are located until 8 sectors downstream from the finish line.

When one or more racing cars 110 are identified as within a sector 620, processor 140 determines their order. If multiple racing cars 110 are present in the same sector, then processor 140 determines the distance between each car and the edge of the sector 620 based on the geographic coordinates, and potentially other data position and/or movement data (e.g., speed, trajectory, pitch, yaw, etc.). The racing car 110 with the coordinates closest to the sector edge is considered the lead car within that sector 620, the car with the next closest coordinates is the second car, the car with the next closest coordinates is the third car, etc.

If the sector is only occupied by a single car, then the distance measurement can be skipped and that car is designated as the lead car. In the alternative, the distance measurement can still be performed, if for no other reason than simply consistency of programming.

The above process will thus yield the accurate order of cars within the sector under examination. In this specific case, as this is the sector with the lead car, the first car will be designated as the leader, and all cars behind it are assigned a sequentially decreasing rank as appropriate.

Processor 140 will then examine the next closest preceding sector. As above, the order of racing cars 110 will be determined for that sector. Processor 140 will then rank those cars in order behind the adjacent forward sector.

The pit area 640 of the race track 610 is technically a point in the race in a branch off of the main track, and needs to be monitored in its own right. Thus, the pit area 640 (including the on and off ramp) may itself be its own sector 620 or multiple sectors 620, or it may be covered by other sectors 620 of the main track 610. Processor 140 can order the cars in the pit relative to the cars in the race consistent with racing protocols.

For example, in FIG. 6 the pit area 640 is show generically as a single sector 620, although multiple sectors could be used (preferably bisecting the pit area along the start/finish line 520, as crossing the line in the pit area 640 does count for lap purposes under current NASCAR rules), these sectors would be prioritized in rank order consistent with prevailing rules, potentially having equal standing with sectors 620 on the main track.

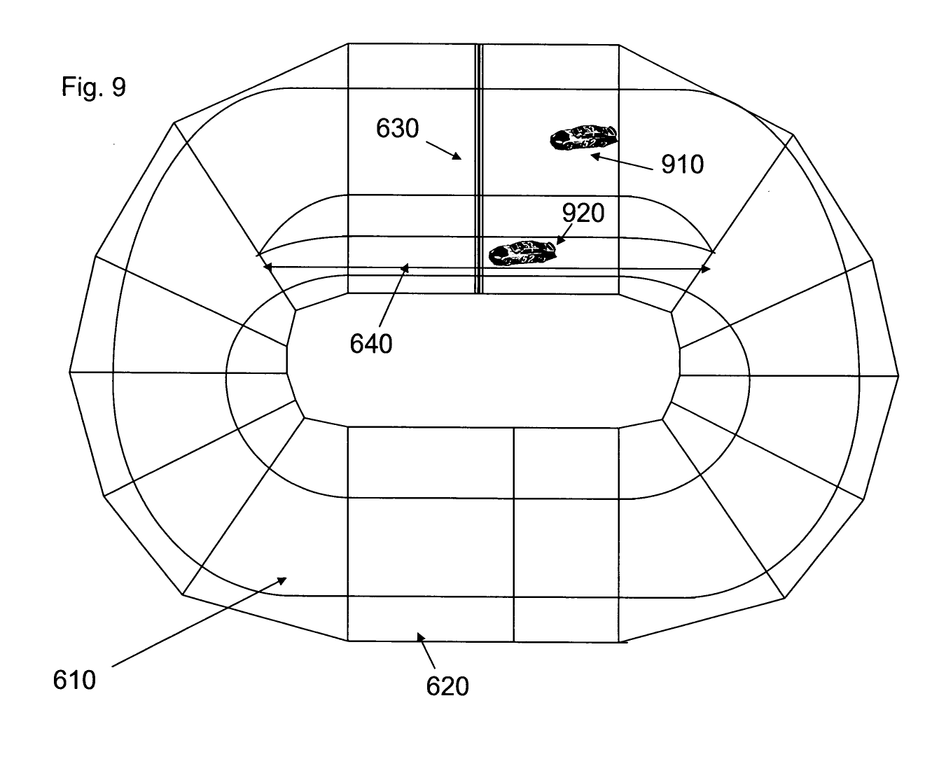

FIG. 9 shows an alternative embodiment in which pit area 640 is includes in parts of four sectors 620. Cars 910 and 920 are both in the same sector 620, although car 920 is in the pit area 640. Car 920 is closer to the forward end of sector 620, and is therefore ahead of car 910.

Eventually the processor 140 will cover all sectors 620 in a single loop of track 610. At this point processor has accounted for the order of cars in the highest particular lap number. Processor 140 with then decrement the lap counter to the next highest lap and isolate the cars in that lap, and begin the process again for the lead sector.

Processor 140 will continue to repeat the above until all cars are accounted for, at which point the processing can end. The order of cars is then set, and can be stored in memory and/or displayed in monitors for whatever use as appropriate.

There are numerous modifications that could be made to the above methodology. By way of non-limiting example, sectors with no cars could be eliminated at the outset from the sequence to study for positioning. The examination could begin from the tail end of the race, by beginning from the start/finish line and looking upstream (into the direction of race travel) into sectors for the cars in the lowest lap, ranking them in reverse order until the lead car is located. An intermediate sector could also be used, with examination proceeding upstream and downstream.

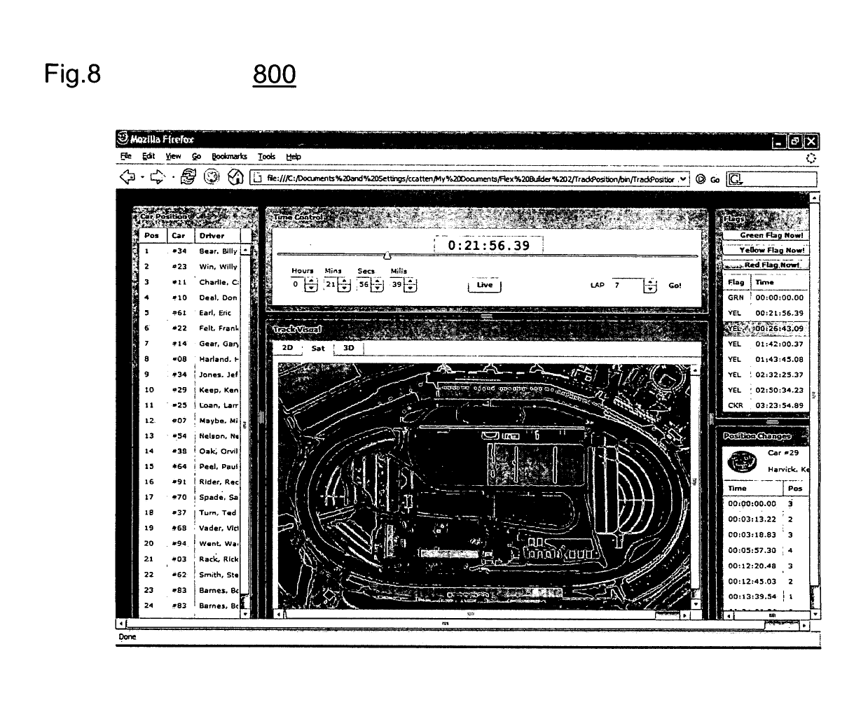

FIG. 8 shows an embodiment of a graphic user interface 800 for use in the invention. The screen shows a generally central image of the auto race track of interest. Above the track is a time selector, which can be the current time or a prior period if the user wishes to observe a past status of the race (including a replay of prior race events of interest). Various types of information relating to the race is shown around the race track visual, including the order of the racers, times of flag conditions, lead changes, etc. This data may represent current race conditions and/or prior race conditions at a selected time. A user can interact with the GUI using a standard mouse and keyboard.

The information collected on car positioning and sequence can be used for a variety of purposes. According to a preferred embodiment of the invention, the methodology could be used to accurately determine the positions of cars during a “yellow flag” state, during which state the cars must remain in order. The data can also be used to provide the order of cars, in real time, without the need for a staff of spotters.

The availability of such data also offers potential for use in gaming and viewing environments. At present, viewing of races is limited to the various cameras placed around the track and cars, and as may be accessible via television or the interne. Embodiments of the present invention allow the entire race to be presented from a virtual perspective, such as a video game environment, to give the viewer the ability to customize his/her perspective.

By way of example, video games often showcase tracks and cars against which the user can race; the track and cars are artistically created with the game, and the movement of the race cars in the game is controlled by artificial intelligence. In an embodiment of the invention, the track and cars would be virtual representations of the actual cars and track on which the race is occurring, and the position of the cars would be dictated by their actual position on the track. Essentially the entire race could be reproduced in a virtual environment, and the user could view the race from any perspective within that environment. For example, a user could elect the viewpoint from the front of the lead car, and view the race from that perspective. In another example, the system could allow the user to enter the race as a “virtual” car.

As discussed above, position detector 120 may be a single DGPS based system that gives accurate coordinate data. However, the invention is not so limited. Multiple receivers can be placed at different positions in the car for greater accuracy. Position detector 120 may also provide additional movement information, such as speed, trajectory, yaw, pitch, etc. Processor 140 may rely on some or all of the additional movement data for additional accuracy. By way of example, a racing car 110 with a position detector 120 may give false readings of the car's position if the car is spinning; however, the other movement data can be used to detect and/or compensate for those circumstances. Two position detectors 120 could also identify the presence of the spin.

The embodiments herein relating to lap counters are only valuable for those environments that rely upon multi-lap conditions. Single lap conditions (such as horse racing) typically do not involve lap counters, and therefore that feature of the embodiment could be omitted. In the alternative, the feature could be included, although the system would not find occasion to decrement the lap counter.

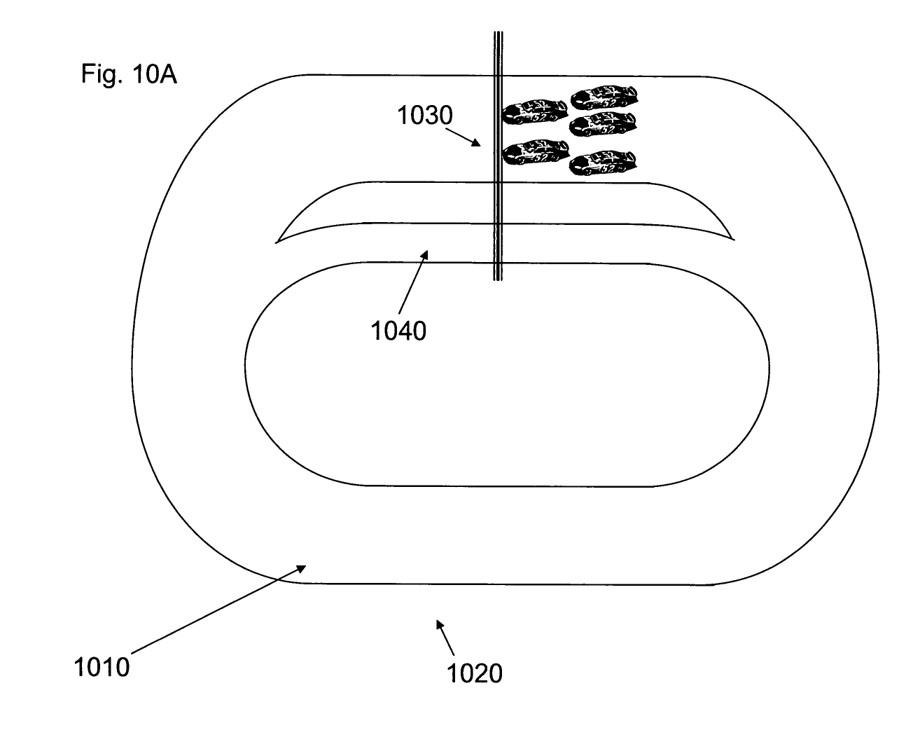

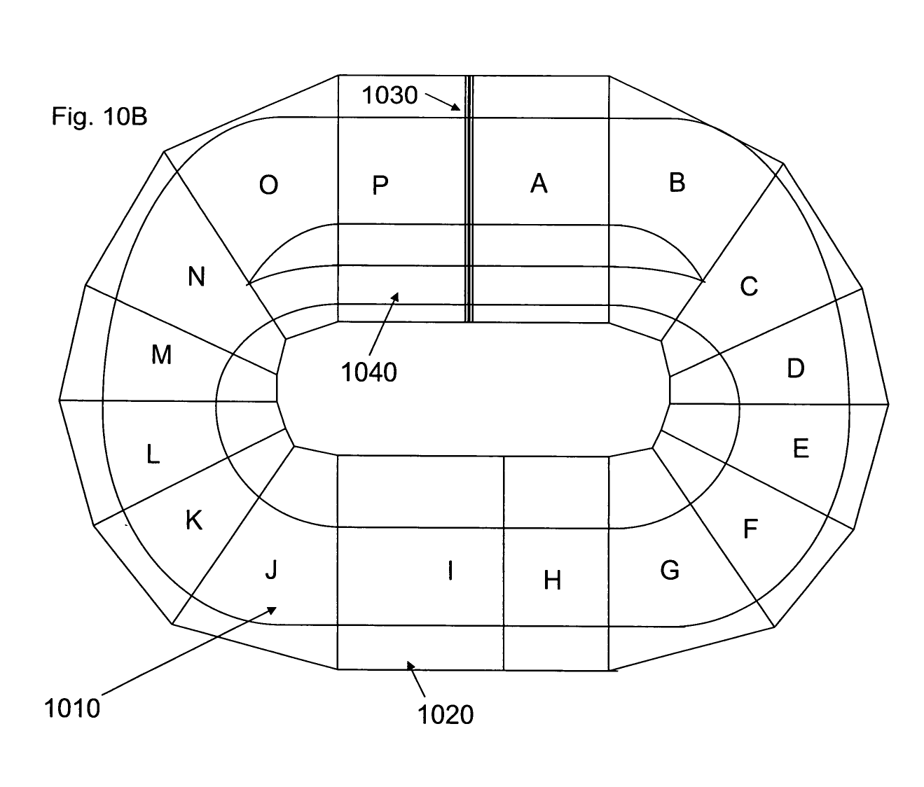

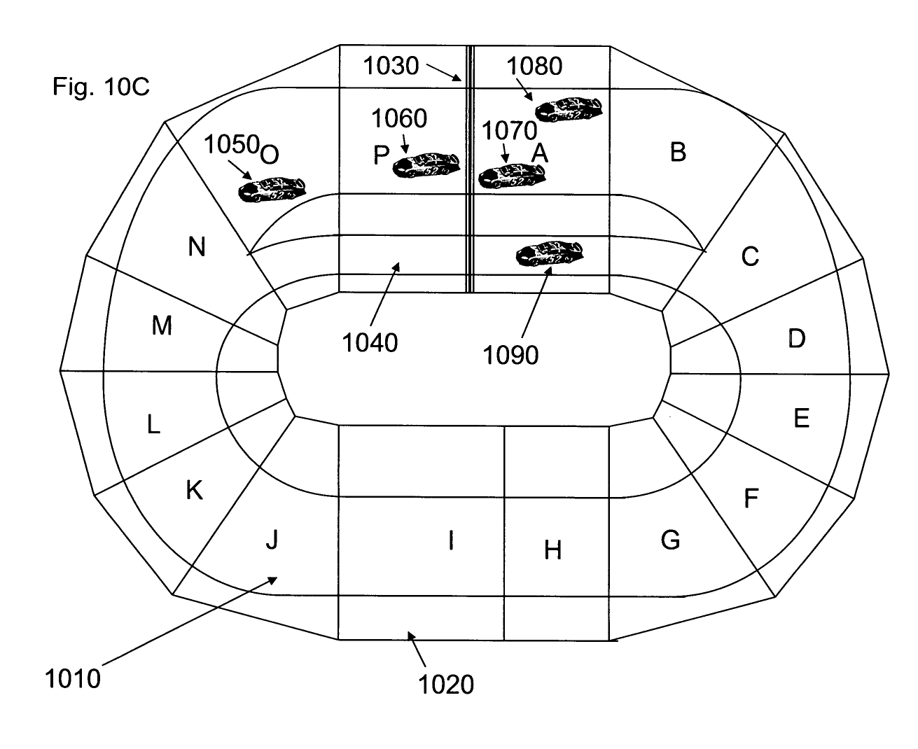

Referring now to FIGS. 10A-10C, an example of the above-embodiments are now shown. FIG. 10A shows a track 1010 that includes a start/finish line 1030 and a pit area 1040. Several cars will race the track. Referring now to FIG. 10B, track 1010 is initially divided into sectors 1020, in this case sectors A-P in rank order from the finish line to the start line 1030.

Referring now to FIG. 3C, the cars have been racing and are transitioning to the 50^{th} lap. Cars 1050 and 1060 have crossed the start line 1030 and are in the 50^{th} lap with car 1050 ahead of car 1060 in sectors O and P, respectively; detection of the specific lap may be through a variety of methods, although in this embodiment the system counts laps by the number of times a particular car crosses from sector P to sector A, both of which share an edge with finish line 1030. Cars 1070, 1080 and 1090 are still in the 49^{th} lap in sector A, although car 1090 is in the pit area 1040. The order of the cars would be determined as follows:
The highest lap is identified, in this case lap 50.
The highest sector in the current lap with at least one car present is identified, in this case sector O. (Even though cars 1070, 1080 and 1090 are in a higher ranked sector (A), they are not part of the current lap such that their positioning is disregarded for the current lap.)
Since only one car (1050) is in sector O, then that car is the leader.
The next highest sector in the current lap with at least one car present is identified, in this case sector P.
Since only one car (1060) is in sector O, then that car is the lead car for sector O.
Since there has been one car identified in a higher ranked sector within this lap, car 1060 is determined to be in second place.
Since there are no more sectors in the current lap with cars, the lap counter is decremented, such that the 49^{th} lap is considered.
The highest sector in the current lap with at least one car present is identified, in this case sector A.
There are three cars in sector A. Using the coordinate data from each car, the system determines that 1070 is closest to the end of sector A, car 1090 is next and car 1080 is last. The system thus sets the positional order within sector A as 1070/1090/1080. Since two cars (1050 and 1060) have been found in a higher ranked lap/sector, then 1070/1090/1080 are in third, fourth, and fifth place, respectively.
The process continues until all cars are accounted for and/or all sectors for all laps have been accounted for.
The standings are displayed on a monitor as:
   First: 1050
   Second: 1060
   Third: 1070
   Fourth: 1080
   Fifth 1090, etc.

Over time, the position of the cars is likely to change. The above process as described with respect to FIG. 10C can be executed at any given time to give positional order in near real time. Further, the positional order at any given time can be stored in computer memory for later review. Accumulation of the stored positional order over time will create a historical record of position order throughout the race.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of any claims as may be advanced in the subject matter, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims any claims as may be advanced in the subject matter.

What is claimed is:

1. A method for ranking the relative movement of objects on a pathway, comprising:
dividing the pathway into a plurality of sectors, each sector having a rank of order with respect to a beginning and an ending point of the pathway;
receiving coordinate data from each of the objects;
identifying, based on the received coordinate data, if any objects are present in individual ones of the plurality of sectors;
determining, for any sector that has at least two objects, the positional order of the at least two objects within that sector; and
ranking the positional order of the plurality of objects along the pathway based upon the rank order of the sector in which each object is present, and which multiple objects that are present in any sector are ordered as set by the determining.

2. The method of claim 1, wherein the pathway defines a closed loop that the plurality of objects will repeatedly travel over a number of laps, the plurality of sectors covering a single lap of the number of laps, the method further comprising:
identifying those of the plurality of objects that are in a first particular lap;
performing the identifying and determining only for those of the plurality of objects that are associated with the first particular lap, while disregarding others of the plurality of objects that are associated with a different lap;
wherein the ranking the positional order of the plurality of objects along the pathway is based upon a rank order of the number of laps, within each lap the rank order of the sectors in which each object is present, in which multiple objects within any sector for any common lap are ordered as set by the determining.

3. The method of claim 1, wherein a forward edge of a highest ranking sector of the plurality of sectors aligns with a predetermined end of the pathway.

4. The method of claim 1, wherein the pathway includes a start line and a finish line, a forward edge of a highest ranking sector of the plurality of sectors aligns with the finish line, and a rearward edge of the lowest ranking sector of the plurality of sectors aligns with the start line.

5. The method of claim 4, wherein the pathway defines a loop, and the start line and the finish line are the same line.

6. The method of claim 1, further comprising visually displaying the positional order as established by the ranking.

7. The method of claim 1, further comprising recursively performing the receiving, identifying, determining, and ranking steps, such that the positional order of the objects as they move along the pathway is monitored and updated.

8. The method of claim 1, wherein the recursively performing occurs in near real-time.

9. The method of claim 1, wherein the determining comprises determining from the received coordinate data the distance of each of the at least two objects to a forward edge of the sector, and ordering the at least two objects based upon the shortest to longest distance.

10. The method of claim 1, wherein the determining comprises determining from the received coordinate data the distance of each of the at least two objects to a rear edge of the sector, and ordering the at least two objects based upon the longest to shortest distance.

11. The method of claim 1, the ranking further comprising:
for each sector, recursively in rank order sequence from the highest to the lowest, listing the objects in each sector to collectively provide a priority order list of the objects for the plurality of sectors.

12. The method of claim 1, the ranking further comprising:
for each sector that includes an object, recursively in rank order sequence from the highest to the lowest, listing the objects in each sector to collectively provide a priority order list of the objects for the plurality of sectors.

13. The method of claim 1, wherein the pathway has at least one branch.

14. The method of claim 1, wherein the branch is a pit area with an entrance and an exit that connects to the pathway, and the dividing step includes the pit area.

15. A method for ranking the relative movement of objects that are lapping a pathway, comprising:
dividing the pathway into a plurality of sectors, each sector having a rank of order with respect to a beginning and an ending point of the pathway;
identifying, for each object on the track, a lap in which the object is in and which of the plurality of sectors the object is in;
determining, for any sector that has multiple objects in a common lap, the position order of the multiple objects within that sector and common lap; and
generating a positional order of the objects along the pathway based upon the rank order of the lap in which each object is present, within each lap the rank order of the sector in which each object is present, and which multiple objects within any sector within a common lap are ordered as set by the determining.

16. The method of claim 15, wherein a forward edge of a highest ranking sector of the plurality of sectors aligns with a predetermined end of the pathway.

17. The method of claim 15, wherein the pathway includes a start line and a finish line, a forward edge of a highest ranking sector of the plurality of sectors aligns with the finish line, and a rearward edge of the lowest ranking sector of the plurality of sectors aligns with the start line.

18. The method of claim 17, wherein the pathway defines a loop, and the start line and the finish line are the same line.

19. The method of claim 1, further comprising visually displaying the positional order of the objects as established by the ranking.

20. The method of claim 15, further comprising recursively performing the receiving, identifying, determining, and generating steps, such that the positional order of the objects as they move along the pathway is monitored and updated.

21. The method of claim 15, wherein the recursively performing occurs in near real-time.

22. The method of claim 15, wherein the determining comprises determining from the received coordinate data the distance of each of the at least two objects to a forward edge of the sector, and ordering the at least two objects based upon the shortest to longest distance.

23. The method of claim 15, wherein the determining comprises determining from the received coordinate data the distance of each of the at least two objects to a rear edge of the sector, and ordering the at least two objects based upon the longest to shortest distance.

24. The method of claim 15, wherein the pathway has at least one branch.

25. The method of claim 15, wherein the branch is a pit area with an entrance and an exit that connects to the pathway, and the dividing step includes the pit area.

26. A method for ranking the relative movement of objects that are lapping a race pathway, comprising:
dividing the pathway into a plurality of sectors, each sector having a rank of order with respect to a beginning and an ending point of the pathway;
receiving coordinate data from each of the objects;
establishing the highest current n^{th} lap in the race, where n is an integer;
recursively for each k^{th} lap in order from n to a lowest lap:
identifying any of the objects in the k^{th} lap;
recursively for each sector, in order from a highest ranking sector to a lowest ranking sector:
identifying whether any of the objects within the k^{th} lap are within the sector; and
if multiple objects are in the sector, determining a positional order of the multiple objects within the sector;
displaying the positional order of the objects along the pathway in lap and sector order, including order of multiple objects within a sector pursuant to the determining.
